(19) United States
(12) Patent Application Publication
(10) Pub. No.: US 2025/0000077 A1
(43) Pub. Date: Jan. 2, 2025

(54) SYSTEM AND METHOD FOR CONTROLLING THE OPERATION OF AN AGRICULTURAL SPRAYER

(71) Applicants: CNH Industrial Italia S.p.A., Turin (CH); CNH Industrial Canada, Ltd., Saskatoon (CA); CNH Industrial America LLC, New Holland, PA (US)

(72) Inventors: Luca Ferrari, Formigine (IT); Blaine Schwalbe, Valders, WI (US); Gerard Gadzella, Saskatoon (CA); Roy A. Bittner, Reedsville, WI (US)

(21) Appl. No.: 18/215,629

(22) Filed: Jun. 28, 2023

(51) Int. Cl. A01M 7/00

(52) U.S. Cl. CPC A01M 7/0089; A01M 7/0014; A01M 7/0057

(57) ABSTRACT

A system for controlling an operation of an agricultural sprayer includes a boom assembly having a frame, a boom arm coupled to the frame, and a nozzle assembly supported on the boom arm. Furthermore, the system includes a sensor configured to generate data indicative of a position of the boom arm relative to the frame in a plane defined by a lateral direction and a vertical direction, which are perpendicular to a travel direction of the sprayer. Additionally, a computing system is configured to determine the position of the nozzle assembly relative to the frame in the plane defined by the lateral direction and the vertical direction based on the data generated by the sensor. Additionally, the computing system is configured to control an operation of the nozzle assembly based on the determined position of the nozzle assembly relative to the frame.

### FIELD OF THE INVENTION

The present disclosure generally relates to agricultural sprayers and, more particularly, to systems and methods for controlling the operation of an agricultural sprayer.

### BACKGROUND OF THE INVENTION

Agricultural sprayers apply an agricultural substance (e.g., a pesticide) onto an underlying field as the sprayer travels across the field. In general, the agricultural substance is applied at a target application rate to achieve a desired agricultural outcome (e.g., a reduction in weed coverage or insect activity). As such, a typical sprayer includes a boom assembly having a frame and one or more boom arms coupled to the frame. Furthermore, a plurality of spaced apart nozzle assemblies is mounted on the boom arm(s). Each nozzle assembly is, in turn, configured to dispense or otherwise spray the agricultural substance onto the underlying field at the target application rate.

However, during operation, the agricultural sprayer may encounter bumps, divots, and/or other impediments within the field. Contact with field impediments may cause the boom arm(s) and the nozzle assemblies mounted thereon to move relative to the frame. Such movement of the nozzle assemblies may result in overapplication of the agricultural substance to some portions of the field and underapplication of the agricultural substance to other portions of the field. In such instances, the target application rate of the agricultural substance is not met, and the desired agricultural outcome may not be achieved.

Accordingly, an improved system and method for controlling the operation of an agricultural sprayer would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for controlling an operation of an agricultural sprayer. The system includes a boom assembly having a frame and a boom arm coupled to the frame. The boom arm, in turn, extends in a lateral direction from a first end of the boom arm to a second end of the boom arm, with the lateral direction extending perpendicular to a travel direction of the agricultural sprayer. Furthermore, the system includes a nozzle assembly supported on the boom arm, with the nozzle assembly configured to dispense an agricultural substance onto an underlying field. Additionally, the system includes a sensor configured to generate data indicative of a position of the boom arm relative to the frame in a plane defined by the lateral direction and a vertical direction that is perpendicular to the lateral direction and the travel direction. Moreover, the system includes a computing system communicatively coupled to the sensor. In this respect, the computing system is configured to determine a position of the nozzle assembly relative to the frame in the plane defined by the lateral direction and the vertical direction based on the data generated by the sensor. In addition, the computing system is configured to control an operation of the nozzle assembly based on the determined position of the nozzle assembly relative to the frame.

In another aspect, the present subject matter is directed to a method for controlling an operation of an agricultural sprayer. The agricultural sprayer, in turn, includes a boom assembly having a frame and a boom arm coupled to the frame, with the boom arm extending in a lateral direction from a first end of the boom arm to a second end of the boom arm and the lateral direction extending perpendicular to a travel direction of the agricultural sprayer. Furthermore, the agricultural sprayer includes a nozzle assembly supported on the boom arm, with the nozzle assembly configured to dispense an agricultural substance onto an underlying field. The method includes receiving, with a computing system, sensor data indicative of a position of the boom arm relative to the frame in a plane defined by the lateral direction and a vertical direction that is perpendicular to the lateral direction and the travel direction. Additionally, the method includes determining, with the computing system, a position of the nozzle assembly relative to the frame in the plane defined by the lateral direction and the vertical direction based on the received sensor data. Moreover, the method includes controlling, with the computing system, an operation of the nozzle assembly based on the determined position of the nozzle assembly relative to the frame.

In a further aspect, the present subject matter is directed to a system for controlling an operation of an agricultural sprayer. The system includes a boom assembly including a frame and a boom arm coupled to the frame. The boom arm, in turn, extends in a lateral direction from a first end of the boom arm to a second end of the boom arm, with the lateral direction extending perpendicular to a travel direction of the agricultural sprayer. In addition, the system includes a nozzle assembly supported on the boom arm, with the nozzle assembly configured to dispense an agricultural substance onto an underlying field. Furthermore, the system includes a sensor configured to generate data indicative of a position of the boom arm relative to the frame in a plane defined by the lateral direction and a vertical direction that is perpendicular to the lateral direction and the travel direction. Additionally, the system includes a computing system communicatively coupled to the sensor. As such, the computing system is configured to determine at least one of a number of or magnitude of oscillations of the boom arm relative to the frame in the plane defined by the lateral direction and the vertical direction based on the data generated by the sensor. Moreover, the computing system is configured to determine when the boom assembly is worn or damaged based on the determined at least one of the number of or the magnitude of the oscillations.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural sprayer in accordance with aspects of the present subject matter;

FIG. 2 illustrates a top view of one embodiment of a boom assembly of an agricultural sprayer in accordance with aspects of the present subject matter;

FIG. 3 illustrates a front view of one embodiment of a boom arm of a boom assembly of an agricultural sprayer in accordance with aspects of the present subject matter;

FIG. 4 illustrates a schematic view of one embodiment of a system for controlling the operation of an agricultural sprayer in accordance with aspects of the present subject matter;

FIG. 5 illustrates a flow diagram providing one embodiment of control logic for controlling the operation of an agricultural sprayer in accordance with aspects of the present subject matter;

FIG. 6 illustrates a flow diagram providing another embodiment of control logic for controlling the operation of an agricultural sprayer in accordance with aspects of the present subject matter; and

FIG. 7 illustrates a flow diagram of one embodiment of a method for controlling the operation of an agricultural sprayer in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a system and a method for controlling the operation of an agricultural sprayer. As will be described below, the agricultural sprayer includes a boom assembly extending in a lateral direction from a first end to an opposed, second end, with the lateral direction extending perpendicular to the travel direction of the sprayer. Furthermore, the boom assembly includes a frame and one or more boom arms coupled to the frame in a cantilever-like manner. Additionally, the agricultural sprayer includes one or more nozzle assemblies supported on the boom arm(s). The nozzle assembly (ies) is, in turn, configured to dispense an agricultural substance (e.g., a pesticide) onto the underlying field (e.g., the underlying field/soil surface or crop canopy surface).

As indicated above, when the agricultural sprayer encounters a bump, divot, or other field impediment, the boom arm(s) may deflect relative to the frame within a plane defined by the lateral direction and the vertical direction. In such instances, the nozzle assembly (ies) may oscillate relative to the field/canopy surface such that the nozzle assembly (ies) is alternatingly closer to and farther away from the field/canopy surface than a target position. This, in turn, results in the overapplication of the agricultural substance to some portions of the field and the underapplication of the agricultural substance to other portions of the field. Additionally, such deflection varies across the length(s) of the boom arm(s) in the lateral direction. For example, a nozzle assembly closer to the outer end of a boom arm will deflect a greater amount due to the cantilever nature of the boom arm than a nozzle assembly closer to the inner end of the boom arm.

As such, a computing system of the disclosed system is configured to control the operation of the nozzle assembly (ies) to prevent such alternating underapplication and overapplication of the agricultural substance. Specifically, in several embodiments, the computing system is configured to receive sensor data indicative of the position of the boom arm(s) relative to the frame in the plane defined by the lateral and vertical directions. For example, in one embodiment, the sensor data may be image data, such as from a camera(s), depicting at least a portion(s) of the boom arm(s) in the plane defined by the lateral and vertical directions. Alternatively, the sensor data may be movement sensor data, such as from an accelerometer(s) or a strain gauge(s), indicative of movement or position(s) of the boom arm(s) relative to the frame in the plane defined by the lateral and vertical directions. Moreover, the computing system may be configured to determine the position(s) of the nozzle assembly(ies) relative to the frame in the plane defined by the lateral and vertical directions based on the received sensor data. For example, in some embodiments, the computing system may determine the shape(s) of the boom arm(s) in the plane defined by the lateral and vertical directions and/or the angle(s) defined between the boom arm(s) and the frame in the plane defined by the lateral and vertical directions. Moreover, in such embodiments, the computing system may then determine the position(s) of the nozzle assembly(ies) based on the determined shape(s) and/or angle(s). Thereafter, the computing system is configured to control one or more operating parameters of the nozzle assembly(ies) (e.g., the frequency(ies) and/or duty cycle(s) at which the nozzle assembly(ies) is being operated) based on the determined position(s) of the nozzle assembly(ies) relative to the frame.

Controlling the operation of the nozzle assembly(ies) of an agricultural sprayer based on the position(s) of the nozzle assembly(ies) within a plane defined by the lateral and vertical directions improves the operation of the sprayer. More specifically, significant computational resources are required to directly determine the position(s) of the nozzle assembly(ies) relative to the field/canopy surface as the position(s) of the boom arm(s) changes due to movement induced by field impediments and the position of the underly field/canopy surface changes due topographical variations within the field. However, as described above, the disclosed system and method determine the position(s) of the nozzle assembly(ies) relative to the frame (as opposed to the field/canopy surface) and then use this position to control the operation of the nozzle assembly(ies). As such, the disclosed system and method reduce the amount of computing resources needed to control operation of the nozzle assembly(ies), which improves the control and the response time of the nozzle assembly(ies) and reduces the overall computational load on the sprayer.

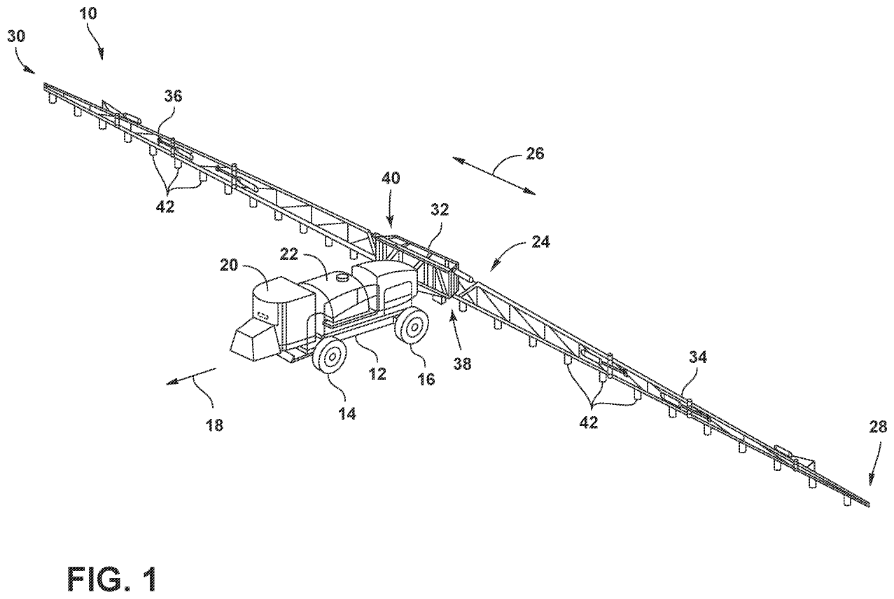

Referring now to the drawings, FIG. 1 illustrates a perspective view of one embodiment of an agricultural sprayer 10. In the illustrated embodiment, the agricultural sprayer 10 is configured as a self-propelled agricultural sprayer. However, in alternative embodiments, the agricultural sprayer 10 may be configured as any other suitable agricultural vehicle that dispenses an agricultural substance (e.g., a pesticide or a nutrient) while traveling across a field, such as an agricultural tractor and an associated implement (e.g., a towable sprayer, an inter-seeder, a side-dresser, and/or the like).

As shown in FIG. 1, the agricultural sprayer 10 includes a chassis 12 configured to support or couple to a plurality of components. For example, a pair of steerable front wheels 14 and a pair of driven rear wheels 16 may be coupled to the chassis 12. The wheels 14, 16 may be configured to support the agricultural sprayer 10 relative to the ground and move the sprayer 10 in a travel direction 18 across the field. Furthermore, the chassis 12 may support a cab 20 and an agricultural fluid tank 22 configured to store or hold an agricultural substance, such as a pesticide (e.g., a herbicide, an insecticide, a rodenticide, and/or the like), a fertilizer, or a nutrient. However, in alternative embodiments, the sprayer 10 may have any other suitable configuration. For example, in one embodiment, the front wheels 14 of the sprayer 10 may be driven in addition to or in lieu of the rear wheels 16.

Additionally, the sprayer 10 may include a boom assembly 24 mounted on the chassis 12. In general, the boom assembly 24 may extend in a lateral direction 26 between a first outer lateral end 28 and a second outer lateral end 30, with the lateral direction 26 extending perpendicular to the travel direction 18. In several embodiments, the boom assembly 24 may include a frame 32 and a pair of boom arms 34, 36. As shown in FIG. 1, a first boom arm 34 extends outwardly in the lateral direction 26 from a first inner lateral end 38 that is coupled to the frame 32 to the first outer lateral end 28. Similarly, a second boom arm 36 extends outwardly in the lateral direction 26 from a second inner lateral end 40 that is coupled to the frame 32 to the second outer lateral end 30. Furthermore, a plurality of nozzle assemblies 42 are supported on the boom assembly 24. Each nozzle assemblies 42 is, in turn, be configured to dispense the agricultural substance stored in the tank 22 onto the underlying field (e.g., the underlying field/soil surface and/or the underlying crop canopy). However, in alternative embodiments, the boom assembly 24 may have any other suitable configuration.

It should be further appreciated that the configuration of the agricultural sprayer 10 described above and shown in FIG. 1 is provided only to place the present subject matter in an exemplary field of use. Thus, it should be appreciated that the present subject matter may be readily adaptable to any manner of agricultural sprayer configuration.

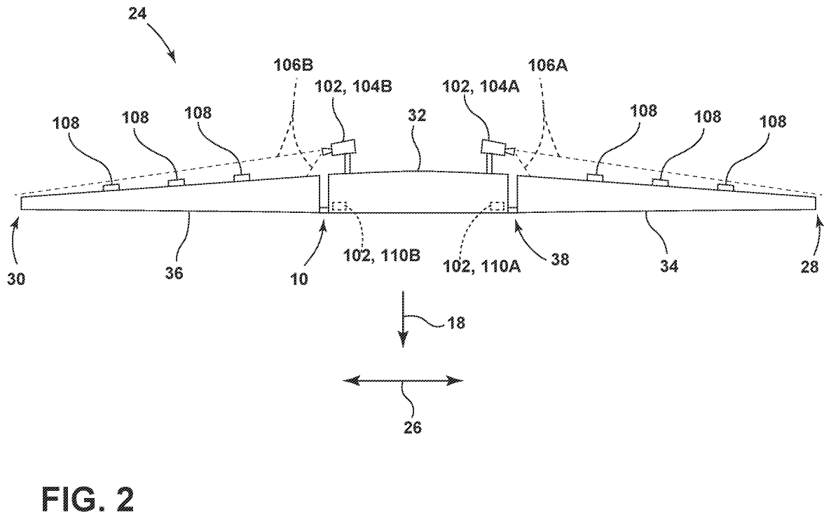

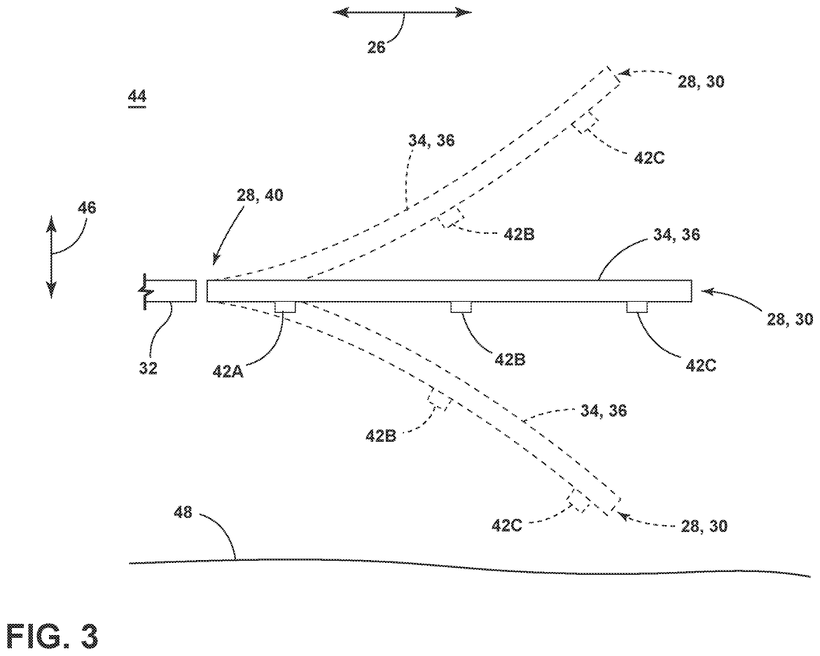

FIG. 2 illustrates a top view of the boom assembly 24 of the agricultural sprayer 10 in accordance with aspects of the present subject matter. In general, the sprayer 10 includes one or more sensors 102 coupled to or supported thereon. Each sensor 102 is, in turn, configured to generate data indicative of the position of one of the boom arms 34, 36 relative to the frame 32 in a plane 44 (FIG. 3) defined by the lateral direction 26 and the vertical direction 46 (FIG. 3) that is perpendicular to the lateral direction 26 and the travel direction 18. As will be described below, the data generated by the sensor(s) 102 is used to control the operation of the nozzle assembly(ies) to prevent alternating underapplication and overapplication of the agricultural substance across the field.

In several embodiments, the sensor(s) 102 may be configured as an imaging device(s) 104. In such embodiments, each imaging devices 104 is configured to generate image data depicting at least a portion of one of the boom arms 34, 36 in the plane 44 defined by the lateral direction 26 and the vertical direction 46 as the agricultural sprayer 10 travels across the field to perform a spraying operation thereon. As will be described below, the image data generated by the imaging device(s) 104 may be analyzed to identify the positions of the nozzle assemblies 42 relative to the frame 32. Thereafter, the nozzle assemblies 42 may be controlled based on the determined positions.

In general, each imaging device 104 may correspond to any suitable device configured to generate images or other image data depicting at least a portion of one of the boom arms 34, 36. For example, in one embodiment, each imaging device 104 may correspond to a camera configured to generate two-dimensional or three-dimensional images of the portion of the one of the boom arms 34, 36 within its field of view. However, in other embodiments, the imaging device(s) 104 may correspond to any other suitable sensing device(s) configured to generate images or image-like data, such as a LiDAR sensor(s) or a RADAR sensor(s).

Any suitable number of imaging devices 104 may be mounted or installed on the agricultural sprayer 10. For example, in the illustrated embodiment, the sprayer 10 includes a first imaging device 104A positioned such that it has a field of view (indicated by dashed lines 106A) directed towards at least a portion of the first boom arm 34. As such, the first imaging device 104A is configured to generate image data depicting at least a portion of the first boom arm 34. Similarly, in the illustrated embodiment, the sprayer 10 includes a second imaging device 104B positioned such that it has a field of view (indicated by dashed lines 106B) directed towards at least a portion of the second boom arm 36. As such, the second imaging device 104B is configured to generate image data depicting at least a portion of the second boom arm 36. However, in alternative embodiments, the sprayer 10 may include any other suitable number of imaging devices 104.

Furthermore, each imaging device 104 may be installed at any suitable location that allows the imaging device 104 to generate images depicting at least a portion of one of the boom arms 34, 36. For example, in some embodiments, the imaging device(s) 104 may be mounted on the frame 32 of the boom assembly 24. However, in alternative embodiments, the imaging device(s) 104 may be installed at any other suitable location(s), such as on the roof of the cab 20 (FIG. 1).

Additionally, in embodiments in which the sensor(s) 102 is configured as the imaging device(s) 104, the boom arms 34, 36 may have one or more targets 108 positioned within the field(s) of view of the imaging device(s) 104. In general, each target 108 corresponds to a component or object that is easily identifiable within the image data generated by the imaging device(s) 104. As such, by identifying the target(s) 108, a computing system analyzing the image data can easily determine the position(s) of the portion(s) of the boom arms 34, 36 where the target(s) 108 is located. Thus, the target(s) 108 may simplify the processing of the image data when identifying the positions of the nozzle assemblies 42 relative to the frame 32, such as when the sprayer 10 has limited onboard computing resources. In this respect, each target 108 may correspond to any suitable component or object on the boom arms 34, 36 that is easily identifiable within the generated image data. For example, the target(s) 108 may correspond to a specific component(s) on the boom arms 34, 36 (e.g., an actuator(s), a particular structural member(s), etc.), a region(s) of a specific color (e.g., a dot(s) or component(s) painted a different color than the surrounding components, etc.), and/or the like. However, in alternative embodiments, the boom arms 34, 36 may not include any specific identifiable targets for use in determining boom arm position.

In other embodiments, the sensor(s) 102 may be configured as a movement sensor(s) 110. In such embodiments, each movement sensor 110 is configured to generate movement data indicative of the movement and/or position of one of the boom arms 34, 36 relative to the frame 32 in the plane 44 defined by the lateral direction 26 and the vertical direction 46. As will be described below, the movement data generated by the movement sensor(s) 110 may be analyzed to identify the positions of the nozzle assemblies 42 relative to the frame 32. Thereafter, the nozzle assemblies 42 may be controlled based on the determined positions.

In general, each movement sensor 110 may correspond to any suitable device configured to generate sensor data indicative of the movement of and/or the position of one the boom arms 34, 36 relative to the frame 32. For example, in one embodiment, each movement sensor 110 corresponds to an accelerometer configured to generate data indicative of the acceleration of one of the boom arms 34, 36 relative to the frame 32. In another embodiment, each movement sensor 110 corresponds to a strain gauge configured to generate data indicative of the position of one of the boom arms 34, 36 relative to the frame 32. However, in other embodiments, the movement sensor(s) 110 may correspond to any other suitable sensing device(s) configured to generate sensor data indicative of the movement of one the boom arms 34, 36 relative to the frame 32.

Moreover, any suitable number of movement sensors 110 may be mounted or installed on the agricultural sprayer 10. For example, in the illustrated embodiment, the sprayer 10 includes a first movement sensor 110A coupled between the first boom arm 34 and frame 32. As such, the first movement sensor 110A is configured to generate movement data indicative of the movement or position of the first boom arm 34 relative to the frame 32. Similarly, in the illustrated embodiment, the sprayer 10 includes a second movement sensor 110B coupled between the second boom arm 36 and the frame 32. As such, the second movement sensor 110B is configured to generate movement data indicative of the movement or position of the second boom arm 36 relative to the frame 32. However, in alternative embodiments, the sprayer 10 may include any other suitable number of movement sensors 110.

In further embodiments, the agricultural sprayer 10 may include one or more of the imaging device(s) 104 and one or more of the movement sensor(s) 110. In such embodiments, the image data from the imaging device(s) 104 and the movement data from the movement sensor(s) 110 may be used together to determine the positions of the nozzle assemblies 42 relative to the frame 32. However, the sprayer 10 may include only the imaging device(s) 104 or only the movement sensor(s) 110.

Moreover, in alternative embodiments, the sensor(s) 102 may be configured as any other suitable type of sensor(s) or sensing device(s) that generate data indicative of the position of the nozzle assemblies 42 relative to the frame 32 in addition to or in lieu of the imaging device(s) 104 and/or the movement sensor(s) 110.

FIG. 3 illustrates a front view of one embodiment of the boom arms 34, 36 of the agricultural sprayer 10. As shown, in the illustrated embodiment, first, second, and third nozzle assemblies 42A-C are supported on the boom arm 34, 36 and spaced apart from each other along the lateral direction 26. Specifically, the first nozzle assembly 42A is positioned adjacent to the inner lateral end 38, 40 of the boom arm 34, 36; the third nozzle assembly 42C is positioned adjacent to the outer lateral end 28, 30 of the boom arm 34, 36; and the second nozzle assembly 42B is positioned at a central location along the boom arm 34, 36 between the inner lateral end 38, 40 and the outer lateral end 28, 30 along the lateral direction 26.

As shown in FIG. 3, the boom arm 34, 36 may move within the plane 44 defined by the lateral direction 26 and the vertical direction 46. More specifically, the agricultural sprayer 10 may encounter bumps, divots, and/or other impediments while traveling across the field to perform a spraying operation thereon. Impact with such an impediment may jar the sprayer 10, thereby causing movement of the boom arm 34, 36 relative to the frame 32. In particular, as mentioned above, the boom arm 34, 36 is coupled to the frame 32 in a cantilever beam-like manner. As such, jarring of the sprayer 10 may cause the boom arm 34, 36 deflect relative to the frame 32. In such instances, the outer lateral end 28, 30 of the boom arm 34, 36 may move upward and down within the plane 44 defined by the lateral direction 26 and the vertical direction 46. For example, in certain instances, the boom arm 34, 36 may oscillate up and down within the plane 44.

Such movement of the boom arm 34, 36 within the plane 44 defined by the lateral direction 26 and the vertical direction 46, in turn, causes the nozzle assemblies 42A-C to move relative to an underlying surface 48 (e.g., a field/soil surface and/or a crop canopy surface). Specifically, such movement may cause one or more of the nozzle assemblies 42A-C to alternatingly be closer to and farther away from the surface 48 than a target position (indicated by solid lines in FIG. 3). For example, when the boom arm 34, 36 deflects upward in the vertical direction 46 (indicated by dashed lines in FIG. 3), the nozzle assemblies 42A-C move farther away from the surface 48 than such nozzle assemblies 42A-C would be when the boom arm 34, 36 is at the target position. In such instances, the greater distance between the nozzle assemblies 42A-C and the surface 48 results in the agricultural substance being dispensed over a larger area of the surface 48. This, in turn, reduces the amount of the agricultural substance being deposited onto a given unit of area of the underlying field, which may reduce the effectiveness of the spraying operation. Conversely, when the boom arm 34, 36 deflects downward in the vertical direction 46 (indicated by dashed lines in FIG. 3), the nozzle assemblies 42A-C move closer to the surface 48 than such nozzle assemblies 42A-C would be when the boom arm 34, 36 is at the target position. In such instances, the smaller distance between the nozzle assemblies 42A-C and the surface 48 results in the agricultural substance being dispensed over a smaller area of the surface 48. This, in turn, increases the amount of the agricultural substance being deposited onto a given unit of area of the underlying field, which may similarly reduce the effectiveness of the spraying operation.

Moreover, due to the cantilever nature of the boom arm 34, 36, the amount of deflection of the boom arm 34, 36 varies across its length in the lateral direction 26. For example, as shown, the when the boom arm 34, 36 deflects upward in the vertical direction 46, the second nozzle assembly 42B is farther away from the surface 48 than the first nozzle assembly 42A and the third nozzle assembly 42C is farther away from the surface 48 than the second nozzle assembly 42B. In such instances, the amount of the agricultural substance being dispensed onto a given unit of area of the surface 48 decreases as the boom arm 34, 36 extends in the lateral direction 26 from the inner lateral end 38, 40 to the outer lateral end 38, 30. Conversely, the when the boom arm 34, 36 deflects downward in the vertical direction 46, the second nozzle assembly 42B is closer to the surface 48 than the first nozzle assembly 42A and the third nozzle assembly 42C is closer to the surface 48 than the second nozzle assembly 42B. In such instances, the amount of the agricultural substance being dispensed onto a given unit of area of the surface 48 increases as the boom arm 34, 36 extends in the lateral direction 26 from the inner lateral end 38, 40 to the outer lateral end 38, 30. As will be described below, the systems and methods disclosed herein control the operation of the nozzle assemblies 42 to compensate for such movement of the boom arms 34, 36 such that target application rate is achieved.

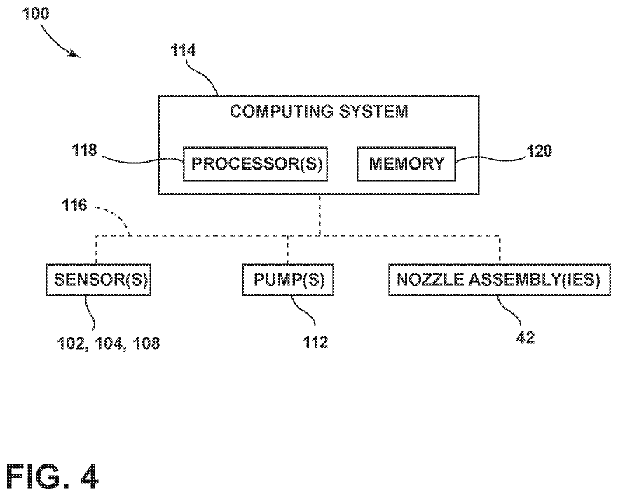

Referring now to FIG. 4, a schematic view of one embodiment of a system 100 for controlling the operation of an agricultural sprayer is illustrated in accordance with aspects of the present subject matter. In general, the system 100 will be described herein with reference to the agricultural sprayer 10 described above with reference to FIGS. 1-3. However, it should be appreciated by those of ordinary skill in the art that the disclosed system 100 may generally be utilized with agricultural sprayers having any other suitable sprayer configuration.

As shown in FIG. 4, the system 100 includes one or more components of the agricultural sprayer 10. For example, in the illustrated embodiment, the system 100 includes one or more of the nozzle assemblies 42 of the sprayer 10 and the sensor(s) 102 (e.g., the imaging device(s) 104 and/or the movement sensor(s) 110).

Furthermore, in some embodiments, the system 100 may include one or more pumps 112 of the sprayer 10. The pump(s) 112 is, in turn, configured to supply the agricultural substance from the tank 22 (FIG. 1) to the nozzle assemblies 42 at a specified flow rate via a plurality of fluid conduits (not shown). In this respect, the operation of the pump(s) 112 can be adjusted to vary flow rate of the agricultural substance to the nozzle assemblies 42.

Moreover, the system 100 includes a computing system 114 communicatively coupled to one or more components of the agricultural sprayer 10 and/or the system 100 to allow the operation of such components to be electronically or automatically controlled by the computing system 114. For instance, the computing system 114 may be communicatively coupled to the sensor(s) 102 (e.g., the imaging device(s) 104 and/or the movement sensor(s) 110) via a communicative link 116. As such, the computing system 114 may be configured to receive data from the sensor(s) 102 (e.g., the imaging device(s) 104 and/or the movement sensor(s) 110) that is indicative of the position(s) of the boom arm(s) 34, 36 relative to the frame 32 in a plane defined by the lateral and vertical directions (e.g., the plane 44 shown in FIG. 3). Furthermore, the computing system 114 may be communicatively coupled to one or more of the nozzle assemblies 42 of the sprayer 10 via the communicative link 116. In this respect, the computing system 114 may be configured to control the operation of the nozzle assembly(ies) 42 to adjust the amount of agricultural substance being dispensed by such nozzle assembly(ies) 42. In addition, the computing system 114 may be communicatively coupled to any other suitable components of the agricultural sprayer 10 and/or the system 100.

In general, the computing system 114 may comprise one or more processor-based devices, such as a given controller or computing device or any suitable combination of controllers or computing devices. Thus, in several embodiments, the computing system 114 may include one or more processor(s) 118 and associated memory device(s) 120 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 120 of the computing system 114 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 120 may generally be configured to store suitable computer-readable instructions that, when implemented by the processor(s) 118, configure the computing system 114 to perform various computer-implemented functions, such as one or more aspects of the methods and algorithms that will be described herein. In addition, the computing system 114 may also include various other suitable components, such as a communications circuit or module, one or more input/output channels, a data/control bus and/or the like.

The various functions of the computing system 114 may be performed by a single processor-based device or may be distributed across any number of processor-based devices, in which instance such devices may be considered to form part of the computing system 114. For instance, the functions of the computing system 114 may be distributed across multiple application-specific controllers or computing devices, such as a spray or application controller, a pump controller, a navigation controller, an engine controller, a transmission controller, and/or the like.

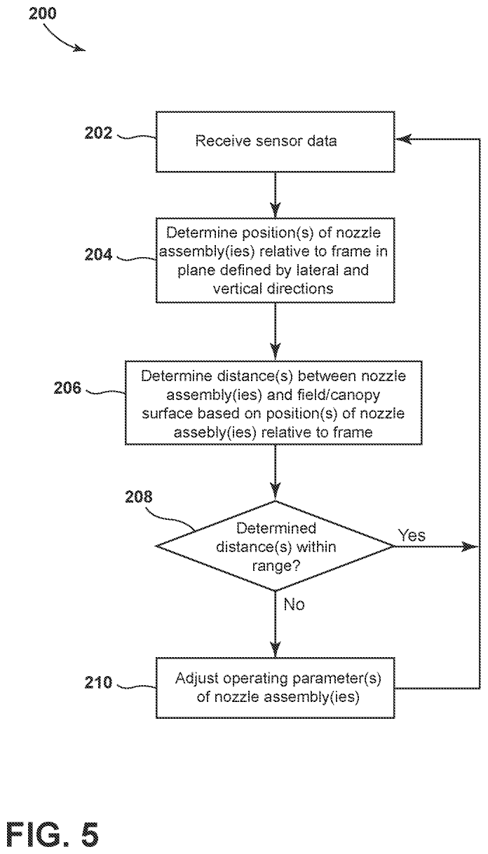

Referring now to FIG. 5, a flow diagram of one embodiment of control logic 200 that may be executed by the computing system 114 (or any other suitable computing system) for controlling the operation of an agricultural sprayer is illustrated in accordance with aspects of the present subject matter. Specifically, the control logic 200 shown in FIG. 5 is representative of steps of one embodiment of an algorithm that can be executed to control the operation of an agricultural sprayer in a manner that reduces the necessary computing resources while still allowing for consistent spray quality as the boom arms of the sprayer move a plane defined by the lateral and vertical directions. However, in other embodiments, the control logic 200 may be used in association with any other suitable system, application, and/or the like for controlling the operation of an agricultural sprayer.

As shown, at (202), the control logic 200 includes receiving sensor data indicative of the position(s) of a boom arm(s) of a boom assembly of an agricultural sprayer relative to a frame of the boom assembly in a plane defined by the lateral and vertical directions. Specifically, as mentioned above, in several embodiments, the computing system 114 may be communicatively coupled to the sensor(s) 102 via the communicative link 116. In this respect, as the agricultural sprayer 10 travels across the field to perform a spraying operation thereon, the computing system 114 may receive data from the sensor(s) 102. Such data may, in turn, be indicative of the positions of the boom arms 34, 36 of the boom assembly 24 of the agricultural sprayer 10 relative to the frame 32 of the boom assembly 24 in a plane defined by the lateral and vertical directions (e.g., the plane 44 shown in FIG. 3). As will be described below, the sensor data received at (202) may be used to determine the positions of the nozzle assemblies 42 relative to the frame 32, with such determined positions being used to control the operation of the nozzle assemblies 42.

Any suitable sensor data may be received at (202). For example, in some embodiments, the sensor data received at (202) may be image data generated by the imaging device(s) 104 depicting at least a portion of the boom arms 34, 36 in the plane defined by the lateral and vertical directions. In other embodiments, the sensor data received at (202) may be movement sensor data generated by the movement sensor(s) 110 that is indicative of movement of the boom arms 34, 36 relative to the frame 32 in the plane defined by the lateral and vertical directions. In further embodiments, the sensor data received at (202) may be combination of image data and movement sensor data.

Furthermore, at (204), the control logic 200 includes determining the position(s) of the nozzle assembly(ies) relative to the frame in the plane defined by the lateral direction and the vertical direction based on the received sensor data. Specifically, in several embodiments, the computing system 114 is configured to analyze the sensor data received at (202) to determine the positions of the nozzle assemblies 42 relative to the frame 32 within the plane defined by the lateral and vertical directions. As will be described below, the positions of the nozzle assemblies 42 determined at (204) are then used to control the operation of such nozzle assemblies 42.

In some embodiments, at (204), the control logic 200 may include determining the shape(s) of the boom arm(s) relative to the frame in the plane defined by the lateral and vertical directions based on the received sensor data. Specifically, in such embodiments, the computing system 114 may be configured to analyze the sensor data received at (202) to determine the shapes or curvatures of the boom arms 34, 36 relative to the frame 32 in the plane defined by the lateral and the vertical directions. For example, in certain embodiments, the computing system 114 may analyze the image data received at (202) determine the shapes or curvatures of the boom arms 34, 36 depicted therein. In particular, in one embodiment, the computing system 114 may identify the target(s) 108 positioned on the boom arms 34, 36. In such an embodiment, the computing system 114 may then use the identified target(s) 108 to determine the shapes of the boom arms 34, 36, such as by extending curves or other lines between the identified target(s) 108. However, in other embodiments, the shapes or curvatures of the boom arms 34, 36 may be determined based on received movement data or a combination of received image data and movement data. Thereafter, based on the known positions of the nozzle assemblies 42 along the boom arms 34, 36 and the determined shapes of the boom arms 34, 36, the computing system 114 may be configured to determine the positions of such nozzle assemblies 42 relative to the frame 32 in the plane defined by lateral and vertical directions.

Additionally, in other embodiments, at (204), the control logic 200 may include determining the angle(s) defined between the boom arm(s) and the frame in the plane defined by the lateral and vertical directions based on the received sensor data. Specifically, in such embodiments, the computing system 114 may be configured to analyze the sensor data received at (202) to determine the angles defined between the boom arms 34, 36 and the frame 32 in the plane defined by the lateral and the vertical directions. For example, in certain embodiments, the computing system 114 may analyze the image data received at (202) determine the angles defined between the boom arms 34, 36 and the frame 32. In particular, in one embodiment, the computing system 114 may identify the target(s) 108 positioned on the boom arms 34, 36. In such an embodiment, the computing system 114 may then use the identified target(s) 108 to determine the angles defined between the boom arms 34, 36 and the frame 32, such as by extending curves or other lines between the identified target(s) 108 and the frame 32. However, in other embodiments, the angles defined between the boom arms 34, 36 and the frame 32 may be determined based on received movement data or a combination of received image data and movement data. Thereafter, based on the known positions of the nozzle assemblies 42 along the boom arms 34, 36 and the determined angles defined between the boom arms 34, 36 and the frame 32, the computing system 114 may be configured to determine the positions of such nozzle assemblies 42 relative to the frame 32 in the plane defined by lateral and vertical directions.

Moreover, in further embodiments, the control logic 200 may include determining both the shape(s) of the boom arm(s) and the angle(s) defined between the boom arm(s) and the frame in the plane defined by the lateral and vertical directions based on the received sensor data. More specifically, the received image data may provide a better indication of the shapes of the boom arms 34, 36 than the movement data. Conversely, the received movement data may provide a better indication of the angles defined between the boom arms 34, 36 and the frame 32 than the image data. Thus, the computing system 114 may determine the shapes of the boom arm 34, 36 based on the received image data and the angles defined between the boom arms 34, 36 and the frame 32 in the plane defined by the lateral and vertical directions based on the received movement sensor data. Thereafter, based on the known positions of the nozzle assemblies 42 along the boom arms 34, 36; the determined angles defined between the boom arms 34, 36 and the frame 32; and the determined shapes of the boom arms 34, 36; the computing system 114 may determine the positions of such nozzle assemblies 42 relative to the frame 32 in the plane defined by lateral and vertical directions.

At (204), the position of each individual nozzle assembly 42 relative to the frame 32 may be determined. More specifically, as described above, when the boom arms 34, 36 deflect relative to the frame 32, the position of each nozzle assembly 42 relative to the frame 32 varies based on its position along the length of the corresponding boom arm 34, 36. Thus, in some embodiments, the computing system 114 may determine the position of each individual nozzle assembly 42 relative to relative to the frame 32 in the plane defined by the lateral and vertical directions based on its the known position along the corresponding boom arms 34, 36; the determined angle defined between the corresponding boom arm 34, 36 and the frame 32; and/or the determined shape of the corresponding boom arms 34, 36. Alternatively, an average or median position of groups of nozzle assemblies 42 or all of the nozzle assemblies 42 on each boom arm 34, 36 may be determined at (204).

In addition, at (206), the control logic 200 includes determining the distance(s) between the nozzle assembly(ies) and the underlying field surface or the underlying canopy surface based on the determined position(s) of the nozzle assembly(ies) relative to the frame. Specifically, in several embodiments, the computing system 114 may be configured to determine the distances between the nozzle assemblies 42 and the underlying field surface or canopy surface in the vertical direction based on the positions of the nozzle assemblies 42 relative to the frame 32 determined at (204). In this respect, by determining the positions of the nozzle assemblies 42 relative to the frame 32 based on received sensor data and then determining the distances between the nozzle assemblies 42 based on the determined positions of the nozzle assemblies 42 relative to the frame 32, the resources necessary to execute the control logic 200 are reduced, thereby improving the accuracy and responsiveness of the spraying operation. As will be described below, the distances determined at (206) are used to control the operation of the nozzle assemblies 42.

As shown in FIG. 5, at (208), the control logic 200 includes determining whether the determined distance(s) is within a predetermined range. Specifically, in several embodiments, the computing system 114 may be configured to compare the distance between each nozzle assembly 42 and the field/canopy surface to a predetermined range. Thereafter, when the distance between a given nozzle assembly 42 and the field/canopy surface is within the predetermined range, the given nozzle assembly 42 is sufficiently close to its target position that no adjustments to its operating parameters are needed. In such instances, the control logic 200 (with respect to the given nozzle assembly 42) returns to (202). Conversely, when the distance between a given nozzle assembly 42 and the field/canopy surface falls outside of the predetermined range, the given nozzle assembly 42 deviates its target position such that adjustments its operating parameters are needed. In such instances, the control logic 200 (with respect to the given nozzle assembly 42) proceeds to (202).

Furthermore, at (210), the control logic 200 includes adjusting one or more operating parameters of the nozzle assembly(ies). Specifically, in several embodiments, when the distance between a given nozzle assembly 42 and the field/canopy surface falls outside of the predetermined range, the computing system is configured to initiate an adjustment to one or more operating parameters of the given nozzle assembly 42. Such adjustment(s) is, in turn, increase or decrease the amount of agricultural substance being dispensed by the given nozzle assembly 42 to compensate for the given nozzle assembly 42 being positioned farther away from or closer to the field/canopy surface than it would be when the corresponding boom arm 34, 36 is at its target position.

In some embodiments, the operating parameter(s) being adjusted may include the frequencies and/or the duty cycles at which the nozzle assemblies are being operated. For example, when the determined distance between a given nozzle assembly 42 and the field/canopy surface exceeds a maximum value of the predetermined range, the frequency and/or the duty cycle may be increased. This, in turn, increases the amount of the agricultural substance being dispensed by the given nozzle assembly 42 to compensate for the greater distance between the given nozzle assembly 42 and the field/canopy surface. Conversely, when the determined distance between a given nozzle assembly 42 and the field/canopy surface falls below a minimum value of the predetermined range, the frequency and/or the duty cycle may be decreased. This, in turn, decreases the amount of the agricultural substance being dispensed by the given nozzle assembly 42 to compensate for the smaller distance between the given nozzle assembly 42 and the field/canopy surface.

Additionally, or alternatively, the operating parameter(s) may include adjusting the pressure of the agricultural substance being supplied to the nozzle assemblies 42. Specifically, the computing system 114 may transmit control signals to the pump(s) 112 via the communicative link 116. The control signals may, in turn, instruct the pump(s) 112 to operate in a manner to increase or decrease the pressure of the agricultural substance being supplied to the nozzle assemblies 42. For example, when the boom arms 34, 36 deflect upward in the vertical direction, all of the nozzle assemblies 42 move farther away from the field/canopy surface (albeit in differing amounts). In such instances, the computing system 114 may transmit control signals instructing the pump(s) 112 to increase the pressure of the agricultural substance being supplied to the nozzle assemblies 42. Conversely, when the boom arms 34, 36 deflect downward in the vertical direction, all of the nozzle assemblies 42 move closer to the field/canopy surface (albeit in differing amounts). In such instances, the computing system 114 may transmit control signals instructing the pump(s) 112 to decrease the pressure of the agricultural substance being supplied to the nozzle assemblies 42.

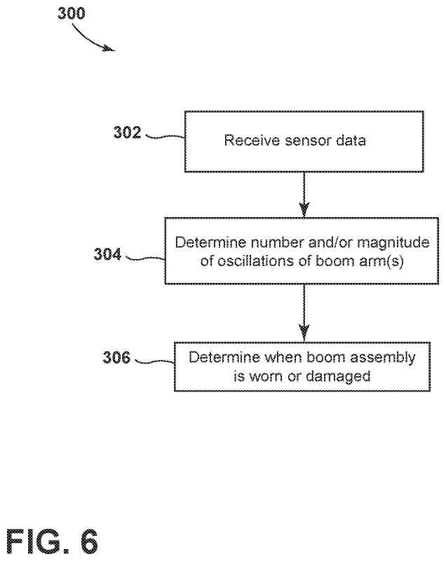

Referring now to FIG. 6, a flow diagram of another embodiment of control logic 300 that may be executed by the computing system 114 (or any other suitable computing system) for controlling the operation of an agricultural sprayer is illustrated in accordance with aspects of the present subject matter. Specifically, the control logic 300 shown in FIG. 6 is representative of steps of one embodiment of an algorithm that can be executed to control the operation of an agricultural sprayer in a manner that allow for determination of the when the boom arm has become damaged or worn. However, in other embodiments, the control logic 300 may be used in association with any other suitable system, application, and/or the like for controlling the operation of an agricultural sprayer.

As shown, at (302), the control logic 300 includes receiving sensor data indicative of the position(s) of a boom arm(s) of a boom assembly(ies) of an agricultural sprayer relative to a frame of the boom assembly in a plane defined by the lateral and vertical directions. (302) is the same as or substantially similar to (202).

Moreover, at (304), the control logic 300 includes determining the number and/or magnitude of oscillations of the boom arm(s) relative to the frame in the plane defined by the lateral direction and the vertical direction based on the received sensor data. Specifically, in several embodiments, the computing system 114 may be configured to analyze the sensor data received at (302) to determine the number of and/or magnitude of the oscillations of the boom arms 34, 36 relative to the frame 32 in the plane defined by the lateral and vertical directions. For example, in some embodiments, the computing system 114 may determine the shapes of the boom arms 34, 36 and/or the angles defined between the boom arms 34, 36 and the frame 32 as described above at a specified frequency or sensor sampling rate. Thereafter, based on each subsequent shape and/or angle determination, the computing system 114 may determine the number to times that the boom arms 34, 36 oscillate and/or the magnitude of such oscillations.

Additionally, at (306), the control logic 300 includes determining when the boom assembly is worn or damaged based on the determined number and/or magnitude of the oscillations of the boom arm(s) relative to the frame in the plane defined by the lateral direction and the vertical direction. Specifically, in several embodiments, the computing system 114 may be configured to determine when the boom assembly 24 is worn or damaged based on the number and/or magnitude of the oscillations of the boom arm(s) 34, 36 relative to the frame 32 in the plane defined by the lateral direction and the vertical direction determined at (304). For example, when the boom arms 34, 36 have oscillated relative to the frame 32 a threshold number of times, the computing system 114 may determine that the boom assembly 24 is worn or damaged. Additionally, or alternatively, when the boom arms 34, 36 have experienced a threshold number of oscillations that exceed a threshold magnitude, the computing system 114 may determine that the boom assembly 24 is worn or damaged.

Furthermore, in certain instances, the control logic 200 and the control logic 300 may be simultaneously executed during operation of the agricultural sprayer 10. That is, in such instances, the positions of the nozzle assemblies 42 in the plane defined by lateral and vertical directions may be used to simultaneously control the operation of such nozzle assemblies 42 for improved spray quality and determine when the boom assembly 24 is worn or damaged. However, in other instances, only the control logic 200 or only the control logic 300 may be executed.

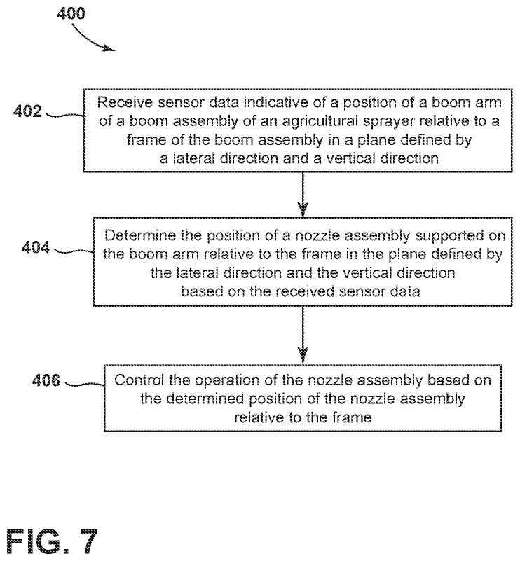

Referring now to FIG. 7, a flow diagram of one embodiment of a method 400 for controlling an operation of an agricultural sprayer is illustrated in accordance with aspects of the present subject matter. In general, the method 400 will be described herein with reference to the agricultural sprayer 10 and the system 100 described above with reference to FIGS. 1-6. However, it should be appreciated by those of ordinary skill in the art that the disclosed method 400 may generally be implemented with any agricultural sprayer having any suitable sprayer configuration and/or within any system having any suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (402), the method 400 includes receiving, with a computing system, sensor data indicative of a position of a boom arm of a boom assembly of an agricultural sprayer relative to a frame of the boom assembly in a plane defined by a lateral direction and a vertical direction that is perpendicular to the lateral direction and a travel direction of the sprayer. For instance, as described above, the computing system 114 may be configured to receive data from the sensor(s) 102. Such sensor data is, in turn, indicative of the positions of the boom arms 34, 36 of the boom assembly 24 of the agricultural sprayer 10 relative to the frame 32 of the boom assembly 24 in a plane defined by the lateral direction and a vertical direction that is perpendicular to the lateral direction and the travel direction (e.g., the plane shown in FIG. 3).

Furthermore, at (404), the method 400 includes determining, with the computing system, the position of a nozzle assembly supported on the boom arm relative to the frame in the plane defined by the lateral direction and the vertical direction based on the received sensor data. For instance, as described above, the computing system 114 may be configured to the positions of the nozzle assemblies 42 supported on the boom arms 34, 36 relative to the frame 32 in the plane defined by the lateral direction and the vertical direction based on the received sensor data.

Additionally, at (406), the method 400 includes controlling, with the computing system, the operation of the nozzle assembly based on the determined position of the nozzle assembly relative to the frame. For instance, as described above, the computing system 114 may be configured to control the operation of the nozzle assemblies 42 based on the determined position of such nozzle assemblies 42 relative to the frame 32.

It is to be understood that the steps of the control logic 200, 300 and the method 400 are performed by the computing system 114 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 114 described herein, such as the control logic 200, 300 and the method 400, is implemented in software code or instructions which are tangibly stored on a tangible computer readable medium. The computing system 114 loads the software code or instructions via a direct interface with the computer readable medium or via a wired and/or wireless network. Upon loading and executing such software code or instructions by the computing system 114, the computing system 114 may perform any of the functionality of the computing system 114 described herein, including any steps of the control logic 200, 300 and the method 400 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for controlling an operation of an agricultural sprayer, the system comprising:
a boom assembly including a frame and a boom arm coupled to the frame, the boom arm extending in a lateral direction from a first end of the boom arm to a second end of the boom arm, the lateral direction extending perpendicular to a travel direction of the agricultural sprayer;
a nozzle assembly supported on the boom arm, the nozzle assembly configured to dispense an agricultural substance onto an underlying field;
a sensor configured to generate data indicative of a position of the boom arm relative to the frame in a plane defined by the lateral direction and a vertical direction that is perpendicular to the lateral direction and the travel direction; and a computing system communicatively coupled to the sensor, the computing system configured to:
determine a position of the nozzle assembly relative to the frame in the plane defined by the lateral direction and the vertical direction based on the data generated by the sensor; and
control an operation of the nozzle assembly based on the determined position of the nozzle assembly relative to the frame.

2. The system of claim 1, wherein, when determining the position of the nozzle assembly, the computing system is configured to:
determine a shape of the boom arm relative to the frame in the plane defined by the lateral direction and the vertical direction based on the data generated by the sensor; and
determine the position of the nozzle assembly relative to the frame in the plane defined by the lateral direction and the vertical direction based on the determined shape.

3. The system of claim 1, wherein, when determining the position of the nozzle assembly, the computing system is configured to:
determine an angle defined between the boom arm and the frame in the plane defined by the lateral direction and the vertical direction based on the data generated by the sensor; and
determine the position of the nozzle assembly relative to the frame in the plane defined by the lateral direction and the vertical direction based on the determined angle.

4. The system of claim 1, wherein, when controlling the operation of the nozzle assembly, the computing system is configured to:
determine a distance between the nozzle assembly and an underlying field surface or an underlying canopy surface based on the determined position of the nozzle assembly relative to the frame; and
control an operating parameter of the nozzle assembly based on the determined distance.

5. The system of claim 4, wherein the operating parameter comprises a pressure of the agricultural substance being supplied to the nozzle assembly.

6. The system of claim 4, wherein the operating parameter comprises at least one of a frequency or a duty cycle at which the nozzle assembly is being operated.

7. The system of claim 1, wherein the sensor comprises an imaging device configured to generate image data depicting at least a portion of the boom arm in the plane defined by the lateral direction and the vertical direction.

8. The system of claim 5, wherein:
the boom arm includes a target positioned thereon; and
when determining the position of the nozzle assembly, the computing system is configured to:
determine position of the target relative to the frame in the plane defined by the lateral direction and the vertical direction; and
determine the position of the nozzle assembly relative to the frame in the plane defined by the lateral direction and the vertical direction based on the determined position of the target.

9. The system of claim 1, wherein the sensor comprises a movement sensor configured to generate movement data indicative of movement of the boom arm relative to the frame in the plane defined by the lateral direction and the vertical direction.

10. The system of claim 9, further comprising:
an imaging device configured to generate image data depicting at least a portion of the boom arm in the plane defined by the lateral direction and the vertical direction,
wherein, when determining the position of the nozzle assembly, the computing system is configured to determine the position of the nozzle assembly relative to the frame in the plane defined by the lateral direction and the vertical direction based on the movement data generated by the movement sensor and the image data generated by the imaging device.

11. The system of claim 1, wherein the nozzle assembly corresponds to a first nozzle assembly, the system further comprising:
a second nozzle assembly supported on the boom assembly and spaced apart from the first nozzle assembly in the lateral direction, the second nozzle assembly configured to dispense the agricultural substance onto the underlying field,
wherein the computing system is further configured to:
determine a position of the second nozzle assembly relative to the frame in the plane defined by the lateral direction and the vertical direction based on the data generated by the sensor; and
control an operation of the second nozzle assembly independently of the first nozzle assembly based on the determined position of the second nozzle assembly relative to the frame.

12. The system of claim 1, wherein the computing system is further configured to determine when the boom assembly is worn or damaged based on the determined position of the nozzle assembly relative to the frame in the plane defined by the lateral direction and the vertical direction.

13. The system of claim 1, wherein the sensor is mounted on the frame.

14. A method for controlling an operation of an agricultural sprayer, the agricultural sprayer including a boom assembly having a frame and a boom arm coupled to the frame, the boom arm extending in a lateral direction from a first end of the boom arm to a second end of the boom arm, the lateral direction extending perpendicular to a travel direction of the agricultural sprayer, the agricultural sprayer further including a nozzle assembly supported on the boom arm, the nozzle assembly configured to dispense an agricultural substance onto an underlying field, the method comprising:
receiving, with a computing system, sensor data indicative of a position of the boom arm relative to the frame in a plane defined by the lateral direction and a vertical direction that is perpendicular to the lateral direction and the travel direction;
determining, with the computing system, a position of the nozzle assembly relative to the frame in the plane defined by the lateral direction and the vertical direction based on the received sensor data; and
controlling, with the computing system, an operation of the nozzle assembly based on the determined position of the nozzle assembly relative to the frame.

15. The method of claim 14, wherein determining the position of the nozzle assembly comprises:
determining, with the computing system, a shape of the boom arm relative to the frame in the plane defined by the lateral direction and the vertical direction based on the received sensor data; and
determining, with the computing system, the position of the nozzle assembly relative to the frame in the plane defined by the lateral direction and the vertical direction based on the determined shape.

16. The method of claim 14, wherein determining the position of the nozzle assembly comprises:
determining, with the computing system, an angle defined between the boom arm and the frame in the plane defined by the lateral direction and the vertical direction based on the received sensor data; and
determining, with the computing system, the position of the nozzle assembly relative to the frame in the plane defined by the lateral direction and the vertical direction based on the determined angle.

17. The method of claim 14, wherein controlling the operation of the nozzle assembly comprises:
determining, with the computing system, a distance between the nozzle assembly and an underlying field surface or an underlying canopy surface based on the determined position of the nozzle assembly relative to the frame; and
controlling, with the computing system, an operating parameter of the nozzle assembly based on the determined distance.

18. The method of claim 17, wherein the operating parameter comprises a pressure of the agricultural substance being supplied to the nozzle assembly.

19. The method of claim 17, wherein the operating parameter comprises at least one of a frequency or a duty cycle of the nozzle assembly at which the nozzle assembly is operating.

20. A system for controlling an operation of an agricultural sprayer, the system comprising:
a boom assembly including a frame and a boom arm coupled to the frame, the boom arm extending in a lateral direction from a first end of the boom arm to a second end of the boom arm, the lateral direction extending perpendicular to a travel direction of the agricultural sprayer;
a nozzle assembly supported on the boom arm, the nozzle assembly configured to dispense an agricultural substance onto an underlying field;
a sensor configured to generate data indicative of a position of the boom arm relative to the frame in a plane defined by the lateral direction and a vertical direction that is perpendicular to the lateral direction and the travel direction; and
a computing system communicatively coupled to the sensor, the computing system configured to:
determine at least one of a number of or magnitude of oscillations of the boom arm relative to the frame in the plane defined by the lateral direction and the vertical direction based on the data generated by the sensor; and
determine when the boom assembly is worn or damaged based on the determined at least one of the number of or the magnitude of the oscillations.
